(19) United States
(12) Patent Application Publication
(10) Pub. No.: US 2026/0238849 A1
(43) Pub. Date: Aug. 13, 2026

(54) DYNAMIC ADJUSTMENT OF AUDIO INTENSITY OUTPUT FOR TARGET USERS

(71) Applicant: DISH Network Technologies India Private Limited, Bangalore (IN)

(72) Inventors: Srinidhi An, Bangalore (IN); Sreevastav Anupuru, Bangalore (IN); PraveenKumar G, Bangalore (IN); Ramegowda Thimmegowda, Bangalore (IN)

(21) Appl. No.: 19/050,954

(22) Filed: Feb. 11, 2025

(51) Int. Cl. H04N 21/439; H04N 21/45

(52) U.S. Cl. CPC H04N 21/439; H04N 21/4532

(57) ABSTRACT

Systems and methods for a content receiver to dynamically adjust intense sounds so as to not scare or shock a user. A normalization period and a normalization factor are selected for content that is to be output to a user of the content receiver. As the content is to be output to the user, a current audio intensity of the content is determined. If the current audio intensity exceeds a threshold, then the current audio intensity is normalized based on the normalization factor and an audio intensity of the content over the normalization period. The content is then output at the normalized audio intensity.

### BACKGROUND

People watch television in a variety of conditions, including different locations and times. Moreover, different people prefer to experience different television in different ways. But some people can be sensitive to certain viewing experiences. One such sensitivity can be elderly people watching a television show that includes sudden screaming or other loud sounds. It is with respect to these and other considerations that the embodiments described herein have been made.

### BRIEF SUMMARY

Briefly, embodiments are directed to systems and methods for dynamically adjusting audio intensity being output to users. A normalization period and a normalization factor are selected for the content that is to be output to a user of a content receiver. Briefly, the normalization period defines an amount of content to be utilized to normalize the audio of the content, and the normalization factor defines the extent in which the content is normalized. As the content is to be output to the user a current audio intensity of the content is determined. If the current audio intensity exceeds a threshold, then the current audio intensity is normalized based on the normalization factor and an audio intensity of the content over the normalization period. The content can then be output to the user at the normalized audio intensity. If the current audio intensity fails to exceed the threshold, then the content can be output to the user at the current audio intensity without being normalized. Normalizing the audio intensity in real time when it exceeds a threshold ensures that the user won't experience a sudden audio rise, which can reduce the likelihood of the user being shocked from an intense sound.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for dynamically adjusting audio intensity being output to target users in accordance with embodiments described herein.

FIG. 2 shows a block diagram of a system for dynamically adjusting audio intensity being output to target users in accordance with embodiments described herein.

FIG. 3 illustrates a logical flow diagram showing one embodiment of a process for dynamically adjusting audio intensity being output to users in accordance with embodiments described herein.

FIG. 4 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments.

However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application.

The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

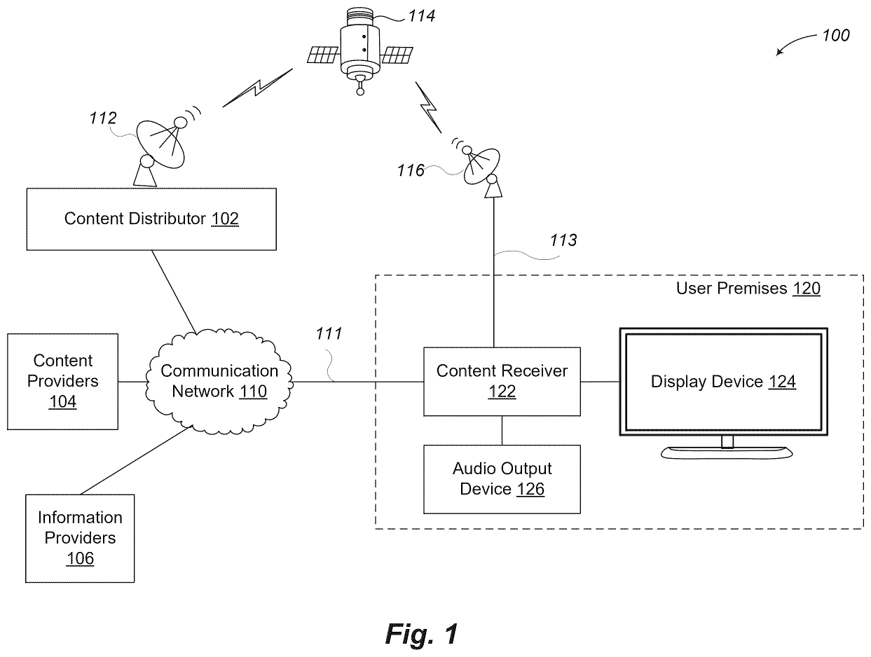

FIG. 1 illustrates a context diagram of an environment 100 for dynamically adjusting audio intensity being output to target users in accordance with embodiments described herein. Environment 100 includes content providers 104, information providers 106, content distributor 102, communication network 110, and user premises 120.

User premises 120 includes a content receiver 122, a display device 124, and an audio output device 126. Examples of the user premises 120 may be a house, apartment, hotel room, senior living environment, hospital room, etc.

The content receiver 122 is a computing device that receives audio content for output via audio output device 126 to a user or viewer on the user premises 120. In some embodiments, the content received by the content receiver 122 includes video content for display via the display device 124. Examples of content receiver 122 may include, but are not limited to, a set-top box, a cable connection box, a computer, television receiver, radio receiver, or other content receivers. The audio output device 126 may be any kind of auditory content presentation device, such as a speaker. The display device 124 may be any kind of visual content display device, such as, but not limited to a television, monitor, projector, or other display device. In some embodiments, the display device 124 and the audio output device 126 may be integrated into a single computing device, such as a television. And in some embodiments, the content receiver 122, the display device 124, and the audio output device 126 may be integrated into a single computing device, such as the user's desktop computer, laptop computer, smart phone, tablet computer, etc. Accordingly, the content receiver 122, the display device 124, and the audio output device 126 may not be limited to the user premises 120 in some embodiments.

As described herein, the content receiver 122 receives content that includes an audio component and normalizes a current audio intensity that is to be output to a user in response to the current audio intensity exceeding a threshold. For example, as the content is received, the output may be delayed a few seconds (e.g., 3 seconds) such that the content receiver 122 can continuously track the audio component of the content. Whenever the content receiver 122 identifies a sudden rise in the audio intensity (e.g., when the current audio intensity exceeds or matches a threshold), the audio intensity is normalized based on a normalization period (e.g., using the audio intensity of the last 5 seconds and next 5 seconds of content) and a normalization factor. The content receiver 122 then outputs the normalized or the non-normalized audio to a user.

The following briefly discusses additional example components in example environment 100. In various embodiments, the content distributor 102 provides content to the content receiver 122. The content distributor 102 may receive a plurality of different content from one or more content providers 104, one or more information providers 106, or a combination thereof. The content distributor 102 provides content and supplemental content, whether obtained from content provider 104 or the data from information provider 106, to a user or viewer through a variety of different distribution mechanisms. For example, in some embodiments, content distributor 102 may provide the content and data to a user's content receiver 122 directly through communication network 110 on link 111. In other embodiments, the content may be sent through uplink 112, which goes to satellite 114 and back to downlink station 116 that may also include a head end (not shown). The content is then sent to an individual content receiver 122 of a user or viewer at user premises 120 via link 113.

Typically, content providers 104 generate, aggregate, and/or otherwise provide content that is provided to one or more users. Sometimes, content providers are referred to as “channels” or “stations.” Examples of content providers 104 may include, but are not limited to: film studios; television studios; network broadcasting companies; independent content producers, such as AMC, HBO, Showtime, or the like; radio stations; or other entities that provide content for user consumption. A content provider may also include individuals that capture personal or home videos and distribute these videos to others over various online media-sharing websites or other distribution mechanisms. The content provided by content providers 104 may be referred to as the program content, which may include movies, sitcoms, reality shows, talk shows, game shows, documentaries, infomercials, news programs, sports programs, songs, audio tracks, albums, or the like. In this context, program content may also include commercials or other television or radio advertisements. It should be noted that the commercials or other advertisements may be added to the program content by the content providers 104 or the content distributor 102. Embodiments described herein may refer generally to content, which includes audio content (e.g., an audio component only) or audiovisual content that includes a video component and an audio component.

In at least one embodiment, information provider 106 creates and distributes data or other information that describes or supports content. Generally, this data is related to the program content provided by content provider 104. For example, this data may include metadata, program name, closed-caption authoring and placement within the program content, timeslot data, pay-per-view and related data, or other information that is associated with the program content. In some embodiments, a content distributor 102 may combine or otherwise associate the data from information provider 106 and the program content from content provider 104, which may be referred to as the distributed content or more generally as content. However, other entities may also combine or otherwise associate the program content and other data together.

In at least one embodiment, communication network 110 is configured to couple various computing devices to transmit content/data from one or more devices to one or more other devices. For example, communication network 110 may be the Internet, X.25 networks, or a series of smaller or private connected networks that carry the content. Communication network 110 may include one or more wired or wireless networks, which may include cellular networks.

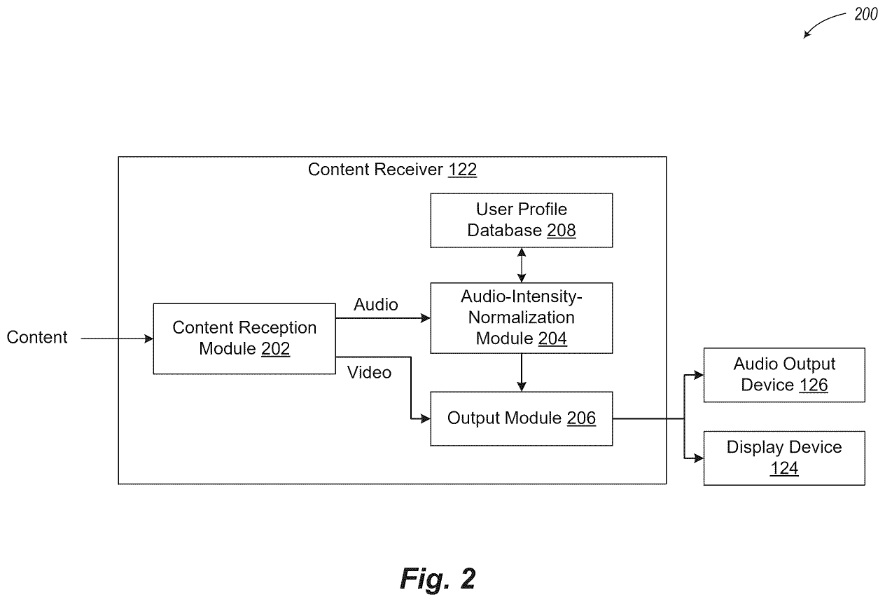

FIG. 2 shows a block diagram of a system 200 for dynamically adjusting audio intensity being output to target users in accordance with embodiments described herein. System 200 includes a content receiver 122, an audio output device 126, and a display device 124, similar to what is shown in FIG. 1. In some embodiments, the display device 124 may be optional and may not be included.

The content receiver 122 includes a content reception module 202, an audio-intensity-normalization module 204, and an output module 206. In some embodiments, the content receiver 122 may optionally include a user profile database 208. The user profile database 208 is configured to store user profiles for one or more users of the content receiver 122. Each user profile may store a normalization period, a normalization factor, audio intensity thresholds, or other information or preferences indicating if and how audio content is to be normalized for a corresponding user. In some embodiments, a user may be presented with a graphical user interface that operates as a training session in which different types of sounds or audio are output to the user, and the user is asked to input whether the sound or audio is too intense or just right. This input may include a measure or gauge of how intense the training audio is to the user (e.g., input of a single number from one to 10). The content receiver 122 may generate the normalization period and the normalization factor for the user and store them in the user profile database 208.

The content reception module 202 is configured to receive content from another computing device or system. The content reception module 202 is configured to separate an audio component from a video component of the content. The content reception module 202 provides the audio component to the audio-intensity-normalization module 204 and the video component to the output module 206. In some embodiments, the content reception module 202 obtains the entire content prior to providing the audio component to the audio-intensity-normalization module 204 and the video component to the output module 206. In other embodiments, the content reception module 202 provides the audio component to the audio-intensity-normalization module 204 and the video component to the output module 206 in real time the content is received at the content receiver 122.

The audio-intensity-normalization module 204 is configured to employ embodiments described herein to normalize the audio component of the content in response to an audio intensity exceeding a threshold. As the audio component of the content is received from the content reception module 202, the audio-intensity-normalization module 204 analyzes the audio to determine if the audio intensity of the current content that is to be output exceeds the threshold. In some embodiments, the audio-intensity-normalization module 204 may access the user profile database 208 to obtain the threshold from a user profile associated with the user of the content receiver. If the current audio intensity exceeds the threshold, then the audio-intensity-normalization module 204 utilizes a normalization period and a normalization factor to normalize the current audio intensity.

As described herein, the normalization period defines a portion of the content to utilize in normalizing the current audio intensity, and the normalization factor defines the extent in which the content is normalized. In some embodiments, the audio-intensity-normalization module 204 may access the user profile database 208 to obtain the normalization period or the normalization factor from a user profile associated with the user of the content receiver.

If the audio-intensity-normalization module 204 normalizes the audio intensity, the audio-intensity-normalization module 204 provides the normalized audio intensity to the output module 206. But if the audio-intensity-normalization module 204 does not normalize the audio intensity (e.g., because the current audio intensity does not exceed the threshold), then the audio-intensity-normalization module 204 provides the current, non-normalized audio intensity to the output module 206.

The output module 206 is configured to provide the normalized or non-normalized audio received from the audio-intensity-normalization module 204 to the audio output device 126 for output to the user. In some embodiments, the output module 206 is also configured to provide the video component of the content to the display device 124 for display or presentation to the user. In various embodiments, the output module 206 may combine the normalized or non-normalized audio with the video component for output to the user.

Although the content reception module 202, the audio-intensity-normalization module 204, and the output module 206 are illustrated as being separate modules, embodiments are not so limited. Rather, the functionality of the content reception module 202, the audio-intensity-normalization module 204, and the output module 206 may be performed by a single module or performed by a plurality of modules. As described herein, a processor system may be utilized to perform the embodiments of t the content reception module 202, the audio-intensity-normalization module 204, and the output module 206.

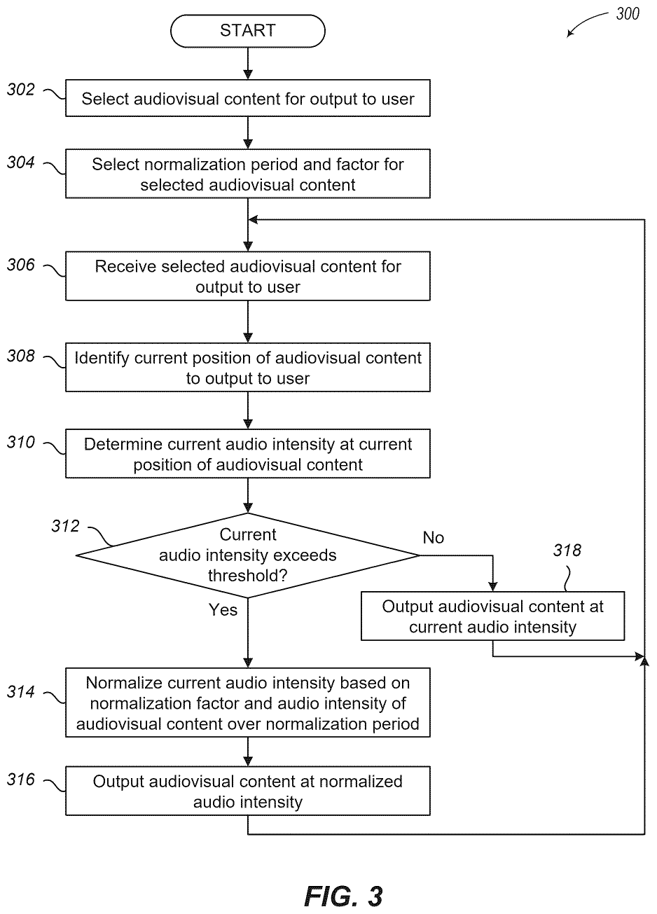

The operation of certain aspects will now be described with respect to FIG. 3.

FIG. 3 illustrates a logical flow diagram showing one embodiment of a process for dynamically adjusting audio intensity being output to users in accordance with embodiments described herein.

Process 300 may be implemented by one or more processors or executed via circuitry on one or more computing devices, such as content receiver 122 in FIG. 1.

Process 300 begins, after a start block, at block 302, where audiovisual content is selected for output to a user. In various embodiments, the audiovisual content may include movies, television shows, sports broadcasts, news broadcasts, advertisements, or other type of content that includes a video component and an audio component to be output to the user. Although process 300 is discussed as receiving and output audiovisual content, embodiments are not so limited. In some embodiments, process 300 may receive, normalize, and output only audio content. The audiovisual content may be selected by the user navigating a content receiver to a specific television channel, the user accessing specific on-demand content, automatically selected (e.g., an advertisement), etc.

Process 300 proceeds, after block 302, to block 304, where a normalization period and a normalization factor are selected for the audiovisual content. The normalization period is a portion of the audiovisual content relative to a current position within the audiovisual content that is to be output to the user, which is used to normalize an audio intensity of the audiovisual content at the current position. In some embodiments, the normalization period is a time period that includes a first amount of time prior to the current position of the content (e.g., 5 seconds prior to the current audio being output) and a second amount of time after the current position of the content (e.g., 5 seconds after to the current audio being output). In other embodiments, the normalization period includes a first number video frames prior to the video frame that corresponds to the current position of the content and a second number of video frames after the video frame that corresponds to the current position of the content.

The normalization factor is a degree or magnitude in which to normalize the current audio intensity. In some embodiments, the normalization factor is a multiplier that is applied when normalizing the current audio intensity. In other embodiments, the normalization factor is a scaling value that is applied when normalizing the current audio intensity.

In some embodiments, the normalization period or the normalization factor, or both, are predefined or preselected for all users and all content. In other embodiments, the normalization period or the normalization factor, or both, is dynamically selected based on the content itself, the user experiencing the audiovisual content, or some combination thereof. For example, in some embodiments, the normalization period or the normalization factor, or both, may be selected based on the genre of the audiovisual content that is to be output to the user (e.g., because a user may be expecting loud sounds in a horror movie compared to a romance movie, the horror movie may have a lower normalization factor than the romance movie). In other embodiments, the normalization period or the normalization factor, or both, may be selected based on the type of content that is to be output to the user (e.g., an advertisement may have a normalization factor different from a movie, and the movie may have a normalization factor different from a live news broadcast). In yet other embodiments, the normalization period or the normalization factor, or both, may be selected based on a demographic of the user. In some embodiments, one or more artificial intelligence or machine learning mechanisms may be employed to train a model from historical normalization periods and factors for other users sharing a demographic with the user. In various other embodiments, each user of a content receiver may have a corresponding profile that stores the normalization period and the normalization factor for that corresponding user, which may be set for different types of content or different genres. In this way, the normalization period or the normalization factor, or both, can be selected for a target user.

Process 300 continues, after block 304, at block 306, where the audiovisual content is received for output to the user. In some embodiments, the audiovisual content may be received as it is to be output to the user, such as for live television, streaming content, on-demand content, or other content output that may be considered in “real time.” Because the normalization of the current audio intensity of the audiovisual content may be normalized over a normalization period that may include a portion of the audiovisual content prior to and after the current position of the content that is to be output to the user, the output of the content may be delayed so as to receive a sufficient portion of the audiovisual content to satisfy the normalization period. In other embodiments, the entire audiovisual content may be received prior to any portion of the audiovisual content being output to the user.

Process 300 proceeds, after block 306, to block 308, where a current position of the audiovisual content is identified for output to the user. In various embodiments, the current position is the video frame and corresponding audio that is to be output at a specific timestamp of the audiovisual content.

Process 300 continues, after block 308, at block 310, where a current audio intensity at the current position of the audiovisual content is determined. In various embodiments, the current audio intensity is power level or root mean square of the audio signal of the audio component of the audiovisual content at the current position, which may correspond to a current video frame of a video component of the audiovisual content at the current position.

Process 300 proceeds, after block 310, 10 decision block 312, where a determination is made whether the current audio intensity exceeds a threshold. This determination is used to determine if the sound level or intensity of the audio that is to be output to the user will be shocking or too intense for the user.

The threshold may be selected based on the user, the type of content, the genre of the content, or some other characteristic of the user or the content. In some embodiments, the threshold may be an audio power level, such an audio power level of the current audio intensity is compared to the audio power level threshold to determine if the current audio intensity exceeds the threshold. In other embodiments, the threshold may be a sound profile for sounds or audio that may be considered intense by the user (e.g., a soundwave profile or signature of the of a gunshot), such that the current audio intensity exceeds the threshold if a comparison between the audio and a plurality of sound profiles indemnifies a match between the audio and a sound profile. If the current audio intensity exceeds the threshold, then process 300 flows to block 314; otherwise, process 300 flows to block 318.

At block 318, the current position of the audiovisual content is output at the current audio intensity. In various embodiments, the audio component of the audiovisual content is output or provided to an audio output device for presentation to the user at the current audio intensity. In some embodiments, a video component of the audiovisual content is also output or provided to a video output device for presentation to the user. After block 318, process 300 loops to block 306 to continue to receive the audiovisual content and advance to a next position for output to the user. In this way, the audio intensity of the audiovisual content is continuously analyzed to determine if the current audio intensity exceeds the threshold in real time as the audiovisual content is being output to the user.

If, at decision block 312, the current audio intensity exceeds the threshold, the process 300 flows from decision block 312 to block 314. At block 314, the current audio intensity is normalized based on the normalization factor and the audio intensity of the audiovisual content over the normalization period. In various embodiments, the current audio intensity is normalized by reducing the current audio intensity relative to the audio intensity of the audiovisual content for the normalization period based on the normalization factor, where the normalization period is a sliding window relative to the current position. In this way, when the audio at the current position of the content is output to the user, the user won't experience a sudden audio rise, which can reduce the likelihood of the user becoming shocked by intense sounds within the content.

Process 300 proceeds, after block 314, to block 316, where the audiovisual content is output at the normalized audio intensity. In various embodiments, the audio component of the audiovisual content is output or provided to an audio output device for presentation to the user at the normalized audio intensity. In some embodiments, a video component of the audiovisual content is also output or provided to a video output device for presentation to the user.

After block 316, process 300 loops to block 306 to continue to receive the audiovisual content and advance to a next position for output to the user. In this way, the audio intensity of the audiovisual content is continuously analyzed to determine if the current audio intensity exceeds the threshold in real time, which allows for the audio intensity to be dynamically adjusted and normalized as the audiovisual content is being output to the user.

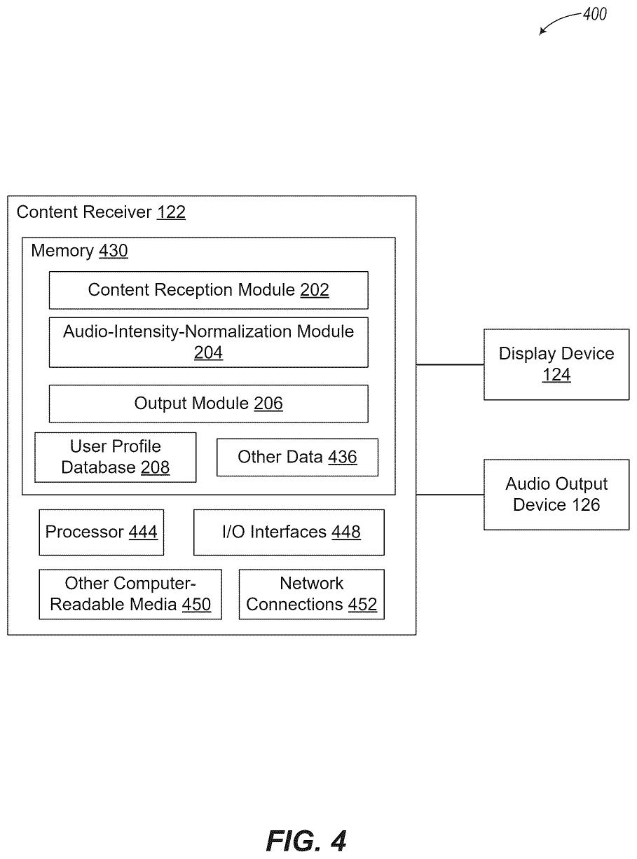

FIG. 4 shows a system diagram that describe various implementations of computing systems for implementing embodiments described herein. System 400 includes content receiver 122, display device 124, and audio output device 126. The display device 124 is configured to display or present a video component of content to a user of the content receiver 122. The audio output device 126 is configured to output or present an audio component of content to the user of the content receiver 122. Although illustrated separately, the display device 124 and the audio output device 126 may be incorporated into a single device (e.g., a television with a built-in speaker).

The content receiver 122 receives and output content to a user. As the content is being processed for output to the user, the content receiver 122 determines if a current audio intensity exceeds a threshold, and if so, normalizes the current audio intensity based on a normalization period and a normalization factor, as described herein. Although illustrated separately, the display device 124 or the audio output device 126, or both, may be incorporated into the content receiver 122 (e.g., if the content receiver 122 is a smartphone).

One or more special-purpose computing systems may be used to implement content receiver 122. Accordingly, various embodiments described herein may be implemented in software, hardware, firmware, or in some combination thereof. Content receiver 122 may include memory 430, processor 444, I/O interfaces 448, other computer-readable media 450, and network connections 452.

Memory 430 may include one or more various types of non-volatile and/or volatile storage technologies. Examples of memory 430 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 430 may be utilized to store information, including computer-readable instructions that are utilized by processor 444 to perform actions, including embodiments described herein.

Processor 444 includes one or more processors, one or more processing units, programmable logic, circuitry, or one or more other computing components that are configured to perform embodiments described herein or to execute computer instructions to perform embodiments described herein. In some embodiments, a processor system of the content receiver 122 may include a single processor 444 that operates individually to perform actions. In other embodiments, a processor system of the content receiver 122 may include a plurality of processors 444 that operate to collectively perform actions, such that one or more processors 444 may operate to perform some, but not all, of such actions. Reference herein to “a processor system” of the content receiver 122 refers to one or more processors 444 that individually or collectively perform actions. And reference herein to “the processor system” of the content receiver 122 refers to 1) a subset or all of the one or more processors 444 comprised by “a processor system” of the content receiver 122 and 2) any combination of the one or more processors 444 comprised by “a processor system” of the content receiver 122 and one or more other processors 444.

Memory 430 may have stored thereon content reception module 202, audio-intensity-normalization module 204, and output module 206, as described herein.

The content reception module 202 is configured to receive or obtain content, such as audiovisual content, that is to be output to a user of the content receiver 122. The audio-intensity-normalization module 204 is configured to determine if the audio intensity exceeds a threshold in real time such that the audio intensity is normalized if it exceeds the threshold prior to be output to the user, as described herein. The output module 206 is configured to output or cause the content to be output via the display device 124 or the audio output device 126. Additional details of the content reception module 202, the audio-intensity-normalization module 204, and the output module 206 are described herein, including in FIG. 2 and elsewhere.

The memory 430 may also store user profile database 208 and other data 436. The user profile database 208 may be a data structure that stores user profiles for one or more users of the content receiver 122. In some embodiments, each user profile includes a normalization factor for a corresponding user, a normalization period for the corresponding user, or other data indicating how to normalize the audio intensity for the corresponding user. The other data 436 may store programs, operating systems, or other information or data.

Network connections 452 are configured to communicate with other computing devices. I/O interfaces 448 may include a keyboard, audio interfaces, video interfaces, or the like, which may enable to the content receiver 122 to output the content via the display device 124 or the audio output device 126. Other computer-readable media 450 may include other types of stationary or removable computer-readable media, such as removable flash drives, external hard drives, or the like.

The following is a summarization of the claims as originally filed.

A method may be performed by a content receiver and may be summarized as comprising: selecting a normalization period and a normalization factor for content to be output to a user of the content receiver; receiving the content; and as the content is to be output to the user: determining a current audio intensity of the content to be output to the user; in response to the current audio intensity exceeding a threshold: normalizing the current audio intensity based on the normalization factor and an audio intensity of the content over the normalization period of the content; and causing the content to be output at the normalized audio intensity; and in response to the current audio intensity failing to exceed the threshold: causing the content to be output at the current audio intensity.

The method may select the normalization period including: selecting a time period that includes a first amount of time prior to the current audio intensity of the content and a second amount of time after the current audio intensity of the content.

The method may select the normalization factor including: selecting an amount of normalization to apply to the current audio intensity of the content.

The method may select the normalization factor including: selecting the normalization factor from a user profile of the user of the content receiver.

The method may select the normalization factor including: selecting the normalization factor based on a demographic of the user of the content receiver.

The method may select the normalization factor including: determining a content type of the content; and selecting the normalization factor based on the determined content type.

The method may select the normalization factor including: determining a genre of the content; and selecting the normalization factor based on the determined genre.

The method may further comprise: defining the threshold as an audio power level.

The method may further comprise: selecting the threshold as a sound profile from a plurality of predefined sound profiles.

A content receiver may be summarized as comprising: a memory configured to store computer instructions; and a processor system configured to execute the computer instructions to: select a normalization period and a normalization factor for audiovisual content to be output to a user of the content receiver; receive the audiovisual content; and as each corresponding video frame of the audiovisual content is to be output to the user: determine an audio intensity of audio associated with the corresponding video frame; in response to the audio intensity associated with the corresponding video frame exceeding a threshold: normalize the audio intensity based on the normalization factor and an audio intensity associated with other video frames of the audiovisual content over the normalization period; and output the corresponding video frame and the audio at the normalized audio intensity to the user; and in response to the audio intensity associated with the corresponding video frame failing to exceed the threshold: output the corresponding video frame and the audio at the audio intensity to the user.

The processor system of the content receiver may select the normalization period by being configured to further execute the computer instructions to: select the normalization period to include a first number video frames prior to the corresponding video frame of the audiovisual content to be output to the user and a second number of video frames after the corresponding video frame of the audiovisual content to be output to the user.

The processor system of the content receiver may select the normalization period by being configured to further execute the computer instructions to: select the normalization period to include a first number seconds prior to the corresponding video frame of the audiovisual content to be output to the user and a second number seconds after the corresponding video frame of the audiovisual content to be output to the user.

The processor system of the content receiver may select the normalization factor by being configured to further execute the computer instructions to: select an amount of normalization to apply to the current audio intensity of the audiovisual content.

The processor system of the content receiver may select the normalization factor by being configured to further execute the computer instructions to: select the normalization factor from a user profile of the user of the content receiver.

The processor system of the content receiver may select the normalization factor by being configured to further execute the computer instructions to: select the normalization factor based on a demographic of the user of the content receiver.

The processor system of the content receiver may select the normalization factor by being configured to further execute the computer instructions to: determine a content type of the audiovisual content; and select the normalization factor based on the determined content type.

The processor system of the content receiver may select the normalization factor by being configured to further execute the computer instructions to: determine a genre of the audiovisual content; and select the normalization factor based on the determined genre.

The processor system of the content receiver may be configured to further execute the computer instructions to: define the threshold as an audio power level.

The processor system of the content receiver may be configured to further execute the computer instructions to: select the threshold as a sound profile from a plurality of predefined sound profiles.

A system may be summarized as comprising: a video output device configured to display a video component of audiovisual content; an audio output device configured to present an audio component of audiovisual content; and a content receiver. The content receiver may comprise: a memory configured to store computer instructions; and a processor system configured to execute the computer instructions to: receive audiovisual content to output to a user of the system; and as the audiovisual content is to be output to the user: determine a current audio intensity of the audio component of the received audiovisual content; and in response to the current audio intensity exceeding a threshold: normalize the current audio intensity based on a normalization factor and an audio intensity of the audio component the received audiovisual content over a normalization period; display the video component of the received audiovisual content via the video output device; and present the audio component of the received audiovisual content at the normalized audio intensity via the audio output device; and in response to the current audio intensity failing to exceed the threshold: display the video component of the received audiovisual content via the video output device; and present the audio component of the received audiovisual content at the current audio intensity via the audio output device.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled.

Accordingly, the claims are not limited by the disclosure.

1. A method, comprising:
selecting, by a content receiver, a normalization period and a normalization factor for content to be output to a user of the content receiver, including:
selecting the normalization period as an amount of time within the content relative to a current audio intensity of the content that is to be output;
receiving, by the content receiver, the content; and
as the content is to be output to the user:
determining, by the content receiver, the current audio intensity of the content to be output to the user;
in response to the current audio intensity exceeding a threshold:
normalizing, by the content receiver, the current audio intensity based on the normalization factor and an audio intensity of the content over the normalization period of the content; and
causing, by the content receiver, the content to be output at the normalized audio intensity; and
in response to the current audio intensity failing to exceed the threshold:
causing, by the content receiver, the content to be output at the current audio intensity.

2. The method of claim 1, wherein selecting the normalization period comprises:
selecting, by the content receiver, the normalization period to include a first amount of time prior to the current audio intensity of the content and a second amount of time after the current audio intensity of the content.

3. The method of claim 1, wherein selecting the normalization factor comprises:
selecting, by the content receiver, an amount of normalization to apply to the current audio intensity of the content.

4. The method of claim 1, wherein selecting the normalization factor comprises:
selecting, by the content receiver, the normalization factor from a user profile of the user of the content receiver.

5. The method of claim 1, wherein selecting the normalization factor comprises:
selecting, by the content receiver, the normalization factor based on a demographic of the user of the content receiver.

6. The method of claim 1, wherein selecting the normalization factor comprises:
determining, by the content receiver, a content type of the content; and
selecting, by the content receiver, the normalization factor based on the determined content type.

7. The method of claim 1, wherein selecting the normalization factor comprises:
determining, by the content receiver, a genre of the content; and
selecting, by the content receiver, the normalization factor based on the determined genre.

8. The method of claim 1, further comprising:
defining, by the content receiver, the threshold as an audio power level.

9. The method of claim 1, further comprising:
selecting, by the content receiver, the threshold as a sound profile from a plurality of predefined sound profiles.

10. A content receiver, comprising:
a memory configured to store computer instructions; and
a processor system configured to execute the computer instructions to:
select a normalization period and a normalization factor for audiovisual content to be output to a user of the content receiver, including:
select the normalization period as a sliding window within the audiovisual content relative to a current video frame of the audiovisual content that is to be output;
receive the audiovisual content; and
as each corresponding video frame of the audiovisual content is to be output to the user:
determine an audio intensity of audio associated with the corresponding video frame;
in response to the audio intensity associated with the corresponding video frame exceeding a threshold:
normalize the audio intensity based on the normalization factor and an audio intensity associated with other video frames of the audiovisual content over the normalization period; and
output the corresponding video frame and the audio at the normalized audio intensity to the user; and
in response to the audio intensity associated with the corresponding video frame failing to exceed the threshold:
output the corresponding video frame and the audio at the audio intensity to the user.

11. The content receiver of claim 10, wherein the processor system selects the normalization period by being configured to further execute the computer instructions to:
select the normalization period to include a first number video frames prior to the corresponding video frame of the audiovisual content to be output to the user and a second number of video frames after the corresponding video frame of the audiovisual content to be output to the user.

12. The content receiver of claim 10, wherein the processor system selects the normalization period by being configured to further execute the computer instructions to:
select the normalization period to include a first number seconds prior to the corresponding video frame of the audiovisual content to be output to the user and a second number seconds after the corresponding video frame of the audiovisual content to be output to the user.

13. The content receiver of claim 10, wherein the processor system selects the normalization factor by being configured to further execute the computer instructions to:
select an amount of normalization to apply to the current audio intensity of the audiovisual content.

14. The content receiver of claim 10, wherein the processor system selects the normalization factor by being configured to further execute the computer instructions to:
select the normalization factor from a user profile of the user of the content receiver.

15. The content receiver of claim 10, wherein the processor system selects the normalization factor by being configured to further execute the computer instructions to:
select the normalization factor based on a demographic of the user of the content receiver.

16. The content receiver of claim 10, wherein the processor system selects the normalization factor by being configured to further execute the computer instructions to:
determine a content type of the audiovisual content; and
select the normalization factor based on the determined content type.

17. The content receiver of claim 10, wherein the processor system selects the normalization factor by being configured to further execute the computer instructions to:
determine a genre of the audiovisual content; and
select the normalization factor based on the determined genre.

18. The content receiver of claim 10, wherein the processor system is configured to further execute the computer instructions to:
define the threshold as an audio power level.

19. The content receiver of claim 10, wherein the processor system is configured to further execute the computer instructions to:
select the threshold as a sound profile from a plurality of predefined sound profiles.

20. A system, comprising:
a video output device configured to display a video component of audiovisual content;
an audio output device configured to present an audio component of audiovisual content; and
a content receiver, comprising:
a memory configured to store computer instructions; and
a processor system configured to execute the computer instructions to:
receive audiovisual content to output to a user of the system; and
as the audiovisual content is to be output to the user:
determine a current audio intensity of the audio component of the received audiovisual content; and
in response to the current audio intensity exceeding a threshold:
normalize the current audio intensity based on a normalization factor and an audio intensity of the audio component the received audiovisual content over a normalization period within the received audiovisual content;
display the video component of the received audiovisual content via the video output device; and
present the audio component of the received audiovisual content at the normalized audio intensity via the audio output device; and
in response to the current audio intensity failing to exceed the threshold:
display the video component of the received audiovisual content via the video output device; and
present the audio component of the received audiovisual content at the current audio intensity via the audio output device.
